(19) United States
(12) Patent Application Publication
(10) Pub. No.: US 2014/0244166 A1
(43) Pub. Date: Aug. 28, 2014

(54) APPARATUS AND METHOD FOR IMPROVED GEO-LOCATION OF UTILITY EQUIPMENT

(71) Applicant: EATON CORPORATION, Cleveland, OH (US)

(72) Inventors: Frank Klancher, Pittsburgh, PA (US); David Tallman, Wexford, PA (US)

(73) Assignee: Eaton Corporation, Cleveland, OH (US)

(21) Appl. No.: 13/780,151

(22) Filed: Feb. 28, 2013

(51) Int. Cl. G08B 21/18

(52) U.S. Cl. CPC G08B 21/185
USPC 701/515

(57) ABSTRACT

A system for geographically locating a component of utility equipment may comprise a geo-location interface (GLI) in communication with and in proximity to the component, the GLI having a navigation system that provides geo-location data, wherein the GLI receives an input relating to an operating state of the component and transmits an output containing the geo-location data and an alert relating to the operating state, and at least one remote station that receives a digital message based on the output from the GLI and generates a display based on the digital message.

### BACKGROUND

1. Technical Field

The present teachings relate to using geo-location information in utility applications, and more particularly to a system and method that uses geo-location to monitor and locate utility equipment.

2.Description of the Related Art

Power outages and other service interruptions have long been a problem in the electric utility industry. In some cases, service problems are caused by problems with system components, such as (but not limited to) circuit breakers, switches, generators, fuses, and uninterruptible power supplies. In other cases, service problems are due to problems in the electrical supply or the load connected to the component, such as (but not limited to) short circuit, voltage variation, electrical arcing, power factor, or phase imbalance.

During a service interruption, it is important to quickly identify and locate electrical and other utility equipment out in the field since restoring service requires immediate repair of the malfunctioning equipment. However, there is currently no known way to identify the precise location of electrical equipment. Instead, electrical equipment is located by field workers and other service personnel relying on drawings, training, service call patterns, and/or work experience to locate the equipment. This limited information may not be enough to clearly and/or quickly identify the location of the equipment, which can result in wasted time searching for the faulty equipment before service can be restored. Moreover, the information does not identify the exact nature of the fault in the equipment or the power supply to the equipment, which may cause additional delays while the problem is diagnosed. If a worker discovers that fixing the problem requires tools and/or parts that are not immediately accessible, this may further delay service restoration as the tools or parts are obtained.

There is a desire for a system and method that can quickly pinpoint the geographic location of faulty equipment in a utility, such as electricity, water, gas, cable, etc.

### SUMMARY

A system for geographically locating a component of utility equipment may comprise a geo-location interface (GLI) in communication with and in proximity to the component. The GLI may have a navigation system that provides geo-location data. The GLI may receive an input relating to an operating state of the component and transmit an output having the geo-location data and an alert relating to the operating state. The system may also include at least one remote station that receives a digital message based on the output from the GLI and generates a display based on the digital message.

In another embodiment, a system for geographically locating a component of utility equipment may comprise a GLI in communication with and at generally the same location as the component. The GLI may have a navigation system that provides geo-location data and a logic unit that receives an input relating to the operating state of the component. The logic unit may detect the operating state, generate a digital message based on the operating state, and transmit an output containing the geo-location data and an alert relating to the operating state. The system may further comprising a central station that receives the alert from the GLI and generates a digital message based on the alert. The system may also include a plurality of remote stations that selectively receive the digital message and generate a display based on the digital message.

An embodiment of a central station for a system for geographically locating a component of utility equipment may comprise a non-volatile memory containing instructions and a processor. The processor may be configured to execute the instructions to receive a first message from a geo-location interface (GLI) in communication with a component of utility equipment, to extract a location of the GLI and an operating state of the component from the first message, and to generate a second message to be transmitted to a remote station, the second message including the location of the GLI and the operating state of the component.

### BRIEF DESCRIPTION OF THE DRAWINGS

Embodiments of the invention will now be described, by way of example, with reference to the accompanying drawings, wherein:

FIG. 1 is a representative block diagram illustrating an embodiment of a system for improved geo-location of utility equipment;

FIGS. 2A and 2B illustrate examples of possible displays shown in a remote station in the system of FIG. 1;

FIGS. 3-5 are flow charts illustrating an embodiment of a method that may be performed by a central station in the system of FIG. 1.

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

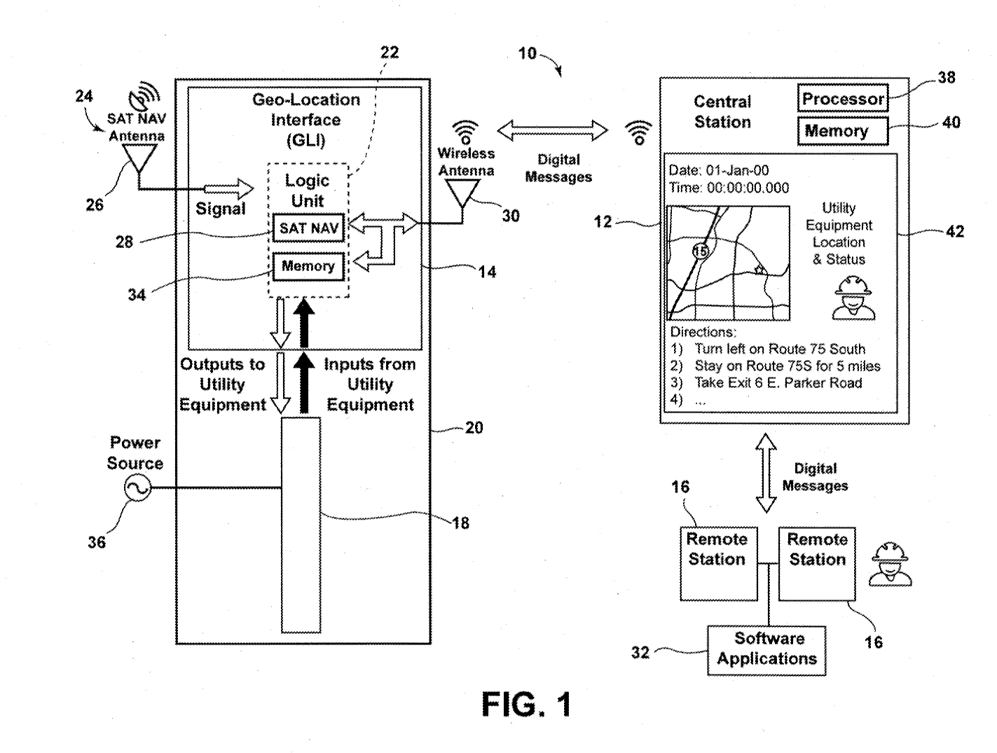

An embodiment of a geo-location system 10 is shown diagrammatically in FIG. 1. Generally, the system 10 allows the location of utility equipment and components, such as electrical components, to be quickly and precisely determined. Although the descriptions and examples herein focus on monitoring, locating, and/or operating electrical components, the teachings can be additionally or alternatively be applied to mechanical, hydraulic, and other components of utility equipment. Furthermore, the present teachings may be applied to utilities such as, but not limited to, electricity, water, gas, and cable. It should be understood that, as used herein, “utility” and “utilities” does not exclude similar types of systems and devices, such as manufacturing systems and devices.

The system 10 may include a central station 12, one or more geo-location interfaces (GLIs) 14, and one or more remote stations 16. The central station 12, the GLIs 14, and the remote stations 16 may communicate with each other via any known means, such as via wireless signals. Each GLI 14 may be associated with one or more pieces or components of utility equipment 18 in the field, such as (but not limited to) electrical components such as circuit breakers, switches, generators, fuses, and/or uninterruptible power supplies. In an embodiment, the remote stations 16 may be mobile devices, such as smartphones or tablet computers, that can be easily and continuously monitored by workers. The central station 12 may update multiple remote stations 16 so that the remote stations 16 display data that is consistent with the current state of the GLI 14 being monitored. In an embodiment, the central station 12 may update two or more remote stations 16 substantially simultaneously.

The GLI 14 may be connected to the utility equipment 18 via any known connection method or mechanism, such as a bolt-on or plug-in connection, for example. In an embodiment, the GLI 14 may be disposed inside an enclosure or housing 20 of the utility equipment 18. However, the GLI 14 may alternatively be disposed outside the housing 20 or other structure of the utility equipment 18, in embodiments.

The GLI 14 may generally include a logic unit 22 and a satellite navigation sub-system 24 (SAT-NAV) to provide geo-location data and location-based service. The SAT-NAV system 24 may include a SAT-NAV processor 28 in communication with a SAT-NAV antenna 26. The SAT-NAV processor 28 may be included in the logic unit 22, in an embodiment. The SAT-NAV processor 28 may operate the SAT-NAV antenna 26 to determine location information. As is known in the art, the SAT-NAV system 24 may be a satellite system that provides autonomous geo-spatial positioning. The SAT-NAV system 24 may include small electronic receivers (e.g., the SAT-NAV antenna 26) to determine and indicate the location of the GLI 14 (i.e., longitude, latitude, altitude) to within a few meters via time signals transmitted from satellites via radio along a line of sight of the satellites. In an embodiment, the SAT-NAV antenna 26 may be a global positioning system (GPS) receiver that provides geo-location data to the SAT-NAV processor 28. Each remote station 16 may also include a GPS receiver (not shown) to provide geo-location data to the central station 12 and/or other remote stations 16.

The GLI 14 may be mounted on or near the utility equipment 18 (i.e., inside the utility equipment component housing 20) to ensure that the location of the GLI 14 and the location of the utility equipment 18 are identical or substantially identical. The logic unit 22 can acquire the geographic coordinates of the GLI 14 (and, by extension, the geographic coordinates of the utility equipment 18) from the SAT-NAV system 24. Alternatively, the logic unit 22 may be manually pre-programmed with geographic location information if, for example, the logic unit 22 and its associated utility equipment 18 will be used in an area where SAT-NAV communication is unavailable.

The GLI 14 may also include a wireless transceiver 30 that transmits location and status data to the central station 12 and/or the remote stations 16 to provide service personnel with accurate information reflecting the operational status of the utility equipment component 18 and/or meter readings from the utility equipment 18, including but not limited to voltage, current, power, temperature, flow rate, and/or equipment fault information.

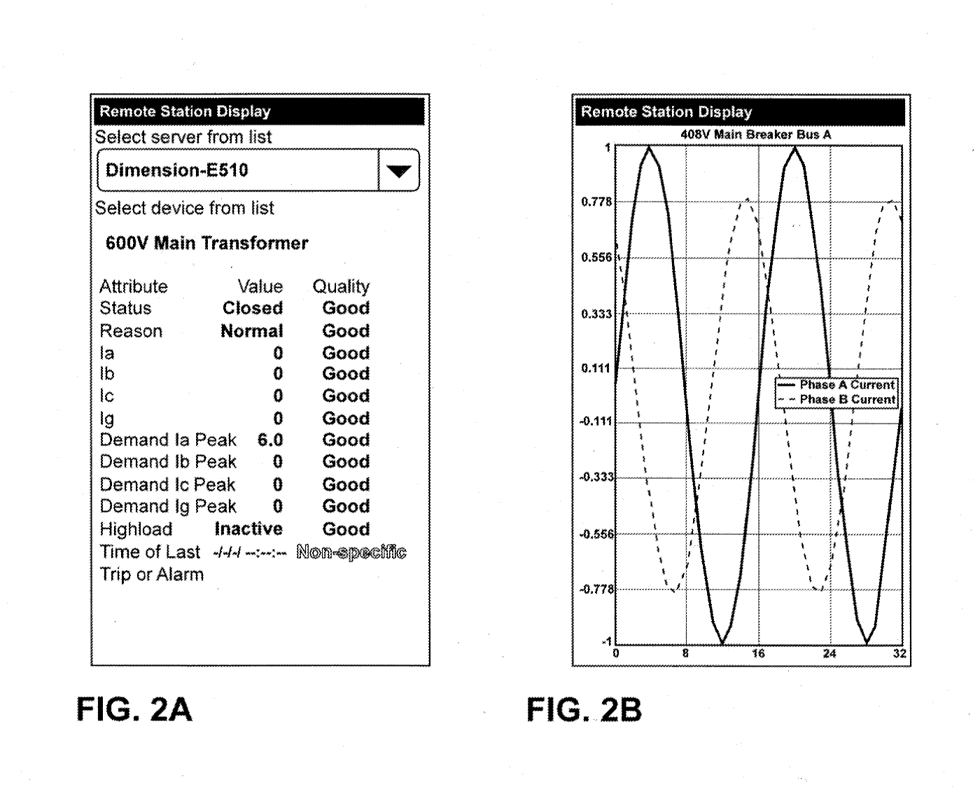

Referring again to FIG. 1, the remote stations 16 may include application software 32 for processing the geo-location and status data and re-transmitting the data to stations connected to other data communication networks. For example, FIGS. 2A and 2B show examples of possible application software displays. In one aspect of the teachings, the remote stations 16 may include one or more communication interfaces (e.g., Wi-Fi, Bluetooth, 3G, 4G LTE, etc.). These interfaces may be used to retransmit data from the GLI 14 over a network that is used to communicate with the GLI 14. For example, a given remote station 16 may use Bluetooth technology to communicate with the central station 12 and retransmit the same data via Wi-Fi to another network using a different communication protocol. This communication flexibility extends the system 10 beyond local networks to wider area networks.

The GLI 14 may include a non-volatile memory 34 for storing data that remains relatively unchanged over time, such as a historical record of events and/or equipment faults in the utility equipment 18, geographic location data (e.g., pre-programmed geographic location coordinates), communication settings and passkeys, and/or specifications and requirements for the utility equipment 18 connected to the GLI 14. To keep the system 10 design simple, the GLI 14 may obtain power directly from the utility equipment component 18 (e.g., from a power source 36 electrically coupled with the utility equipment 18). However, a backup power supply (not shown) may be included to provide power to the GLI 14 if the fault is a power outage affecting an outside power source 36 driving or otherwise electrically coupled with the utility equipment 18.

The GLI 14 (via the logic unit 22) may monitor one or more input signals sent by the utility equipment 18 to the GLI 14 to determine the utility equipment's 18 operational state (e.g., normal or abnormal/faulty) and/or the operational state of one or more components of the utility equipment 18. For example, the GLI 14 may check an operational state of a circuit breaker (e.g., unknown, open, closed, or tripped) by monitoring auxiliary contacts in the breaker. In this example, “open” or “closed” may be considered “normal” operational states while “unknown” or “tripped” may be considered “faulty/abnormal” states. If the input signals indicate a faulty condition in the utility equipment 18, the GLI 14 may activate the wireless transmitter/receiver 30 to send an alert (e.g., a digital message) to the central station 12 and/or remote stations 16. The digital message may include the alert and/or additional information generated by the logic unit 22 to expedite location and repair of the utility equipment 18. Possible additional information may include the geographic location of the GLI 14 (and hence its corresponding utility equipment 18), the cause, time and date of the equipment fault, relevant electrical measurements taken at the time the fault occurred (e.g., a fault data record or event record), and other information about the operational status of components in the utility equipment 18. In one example, the information can also include more specific guidance, such as hazardous location warnings (e.g., dogs, obscure equipment location, electrical arc flash hazard rating, suggested personal protective equipment, etc.) to ensure safe equipment service. The information may also include nearby utility equipment 18 locations in the case of more system-wide and/or cascading equipment faults.

The GLI 14 may also send one or more output signals or messages to the utility equipment 18. In an embodiment, the central station 12 or one of the remote stations 16 may instruct the GLI 14 to generate an output signal to the utility equipment 18, thereby allowing at least some portions or components of the utility equipment 18 to be operated remotely. For example, the remote station 16 may instruct the GLI 14 to send an output signal to reset a tripped circuit breaker in the utility equipment 18. This output signal may be generated automatically, in an embodiment, or may also be generated by an operator at the central station 12.

The remote station 16 may also send one or more signals or messages to, for example, remotely control or operate the utility equipment 18 or a component thereof. Signals or messages sent by the remote station 16 may include a passkey to verify the identity of the remote station 16 or otherwise confirm that the remote station is allowed to remotely operate the utility equipment 18. Remote station output signals or messages may also include settings of the remote station 16 to ensure proper control of the utility equipment 18 from the remote station 16. The output signals or messages from the remote station 16 may also include one or more commands for operating the utility equipment 18 or a component thereof. Such commands may include, for example but without limitation, commands to reset a circuit breaker, open or close a switch, or enable or disable a power supply.

The central station 12 may include a processor 38 for executing one or more functions or instructions described above and below, a non-volatile memory 40 for storing data received from the GLI 14, data received from the remote stations 16, instructions for processing, analyzing, and generating data and signals, and a display 42. The central station 12 may be provided with software applications (e.g., embodied as or accessible through instructions stored in the memory 40) for determining and displaying, for example and without limitation, directions to send to a remote station 16 to instruct a worker how to navigate to a faulty GLI 14, the date and time, and other information.

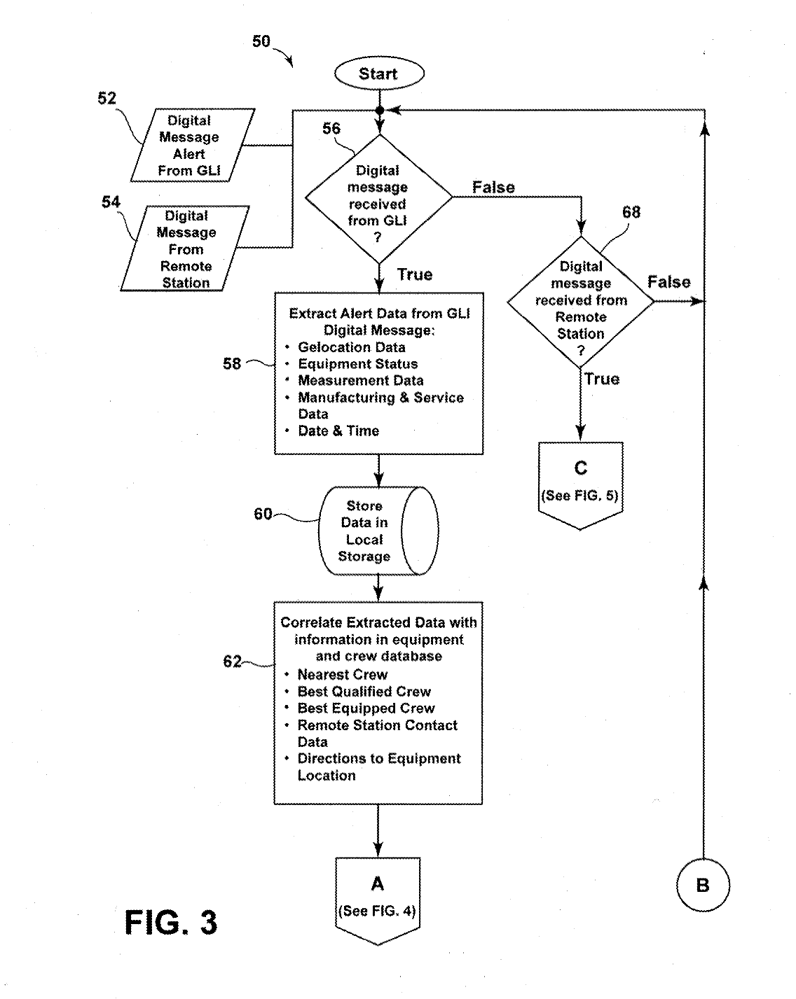

The central station 12 may be configured to receive one or more signals or messages from the GLI 14 and the remote stations 16, as noted above. Once those signals or messages are received, the central station 12 may execute one or more algorithms to process, analyze, store, and transmit signals or messages. Such algorithms may be stored (e.g., as software or instructions) in the central station memory 40 and executed by the processor 38. An exemplary embodiment of one such algorithm 50 is illustrated in FIGS. 3-5.

Referring to FIGS. 1 and 3, the central station 12 may receive, for example but without limitation, a digital message, such as a digital message alert from the GLI 52 or a digital message from a remote station 54. At a first decision step 56, the central station 12 may determine if the digital message was received from the GLI 14. If the message was received from the GLI 14, the central station 12 may proceed to a first processing step 58. At the first processing step 58, the central station 12 may extract alert data from the digital message received from the GLI. Extracted data may include, for example, geo-location data respective of the GLI 14 (and thus respective of the utility equipment 18 to which the GLI is coupled or with which the GLI is in communication or is otherwise associated), equipment status, measurement data, manufacturing and service data, and the date and time. At a storage step 60, the central station 12 may store data extracted in the first processing step 58 in the memory 40.

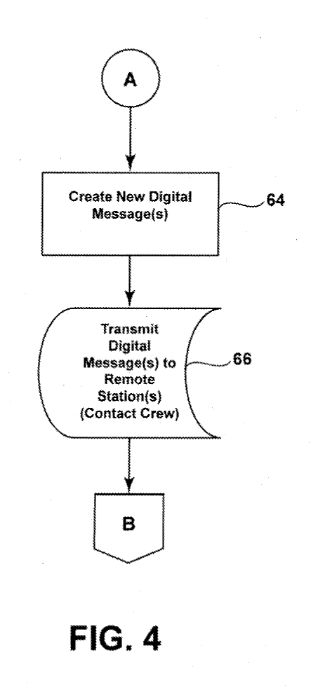

Once the data is stored, the central station 12 can advance to a second processing step 62 to determine how best to address the problem indicated in the digital message from the GLI 52. The second processing 62 step may include, for example, determining and selecting one or more crews to address the problem, which may include the nearest (e.g., determined according to geo-location data respective of one or more remote stations 16, as described in conjunction with FIG. 4 below), best qualified, and/or best equipped work crew, according to received geo-location data and data regarding the problem with the component with which the GLI 14 is associated. The second processing step 62 may include, in an embodiment, displaying information related to the fault and/or one or more service crews on a display 42 of the central station 12. In addition to selecting one or more crews to address the problem, the second processing step 62 may include determining contact information for the one or more selected crews and determining directions (e.g., driving directions) from the location of the remote station 16 to the GLI 14.

Referring to FIGS. 1 and 4, the central station 12 may then proceed to a step 64 of creating one or more new digital messages to send to the one or more selected work crews (i.e., to the remote stations 16 associated with the one or more work crews). The message(s) may include, for example, a map and/or directions to the GLI 14, a description of the equipment fault, suggested service procedures, lists of the required parts, tools, and personal protective equipment needed to remedy the fault, and other data respective of the GLI 14. In an embodiment, the message may be or may include the alert message received from the GLI 14 (i.e., the central station may re-transmit the alert message). The central station 12 may then advance to a step 66 of transmitting the one or more digital messages to the remote station(s) associated with the one or more selected work crews. The work crew(s) may then address the problem with the component to which the GLI 14 is coupled. After the faulty utility equipment 16 is serviced, the logic unit 22 in the GLI 14 may detect the change in state and send an alert/digital message to the central station 12 verifying the “normal” state. The central station 12 may then restart the method 50 for the next received message.

Referring again to FIGS. 1 and 3, at the first decision step 56, if the central station 12 determines that digital message was not received from the GLI 14, the central station 12 can advance to a second decision step 68 and query if the digital message was received from a remote station 16. If the digital message was not received from a remote station 16, then the digital message was received in error or is otherwise not of concern to the central station 12, and the central station 12 can restart the method 50 for the next received message.

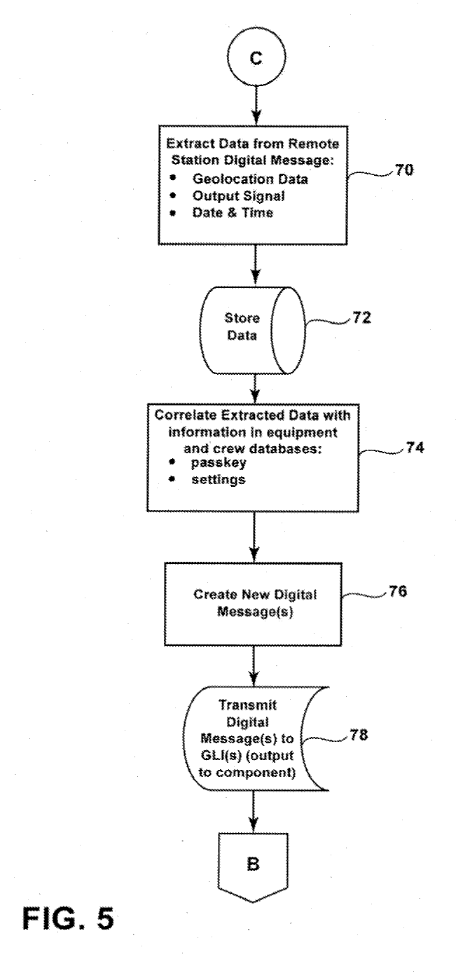

If, at the second decision step 68, the central station determines that the message was received from a remote station 16, the central station 12 may proceed to a number of steps for processing, storing, and transmitting based on the received message. Referring to FIGS. 1 and 5, the central station 12 may proceed to a processing step 70 (i.e., a third processing step 70 in the method 50). At the third processing step 70, the central station 12 may extract data from the received message. Extracted data may include, for example and without limitation, geo-location data respective of the remote station 16, an output signal from the remote station 16, and a date and time. The output signal may include, for example and without limitation, a command involved in the remote operation of the utility equipment 18 with which the GLI 14 is associated, a passkey for verifying that the remote station 16 is permitted to operate the utility equipment 18, and settings of the remote station 16 and/or GLI 14.

Once data is extracted from the received signal, the central station 12 may advance to a step 72 of storing extracted data, and then to another processing step 74 (i.e., a fourth processing step 74 in the method 50). At the fourth processing step 74, the central station 12 may correlate extracted data with information in a database containing data pertaining to equipment and work crews (e.g., maintained in the central station memory 40). For example, the passkey may be cross-referenced with a passkey associated with the GLI 14 or with the remote station 16 to ensure that the remote station 16 or crew operating the remote station 16 is permitted to operate the utility equipment 18 to which the GLI 14 is associated. If the crew and/or remote station 16 passes verification, the central station 12 may proceed to a step 76 of creating one or more new digital messages to be transmitted to the GLI 14. The digital message may include, for example and without limitation, a command for operating the utility equipment 18. The central station 12 may then proceed to a step 78 of transmitting the digital message(s) to the GLI 14, The central station 12 may then restart the method 50 for the next received message.

Although the method 50 is generally described above with reference to a single digital message at a time, the central station 12 may execute one or more steps of the method 50 for multiple received messages in parallel, in an embodiment. Furthermore, although the system 10 and method 50 are described above in terms of routing signals between the GLI 14 and the remote stations 16 via the central station 12, the system 10 can be designed (and the method 50 can be implemented) so that the GLI 14 and the remote stations 16 can communicate directly with each other as well if desired. The central station 12 may act as a signal hub that monitors the GLIs 14 and alerts one or more remote stations 16 if a GLI 14 requires service. However, if the system 10 is designed without a central station 12 signal hub, the remote stations 16 can communicate directly with the GLIs 14 to obtain similar data. Using the central station 12 has the advantage of allowing the remote stations 16 to be activated only when a GLI 14 event occurs (if desired), conserving the remote station 16 batteries by not running the application on the remote station 16 until it is needed. If the system 10 has the central station 12, and the utility equipment 18 is reliable, the remote stations 16 may not need to be operated often, lengthening the battery life of the remote stations 16.

The central station 12 has the advantage of obtaining information from all of the GLIs 14 and analyzing it with respect to additional data stored at the central station 12 to provide the most effective and efficient service. Additional functions that could be carried out in the central station 12 include, but are not limited to, prioritizing service calls, keeping customer service logs, estimating repair time, and/or analyzing outage patterns when multiple GLIs 14 report utility equipment 18 failures. Those of skill in the art will recognize that other functions not named here can be implemented in the central station 12 and/or the remote stations 16 via software.

Note that the functions described above can be carried out via, for example, one or more smartphone software applications 32. Thus, the system 10 and method 50 can easily take advantage of existing wireless communication infrastructures to carry out its functions.

It will be appreciated that the above teachings are merely exemplary in nature and is not intended to limit the present teachings, their application or uses. While specific examples have been described in the specification and illustrated in the drawings, it will be understood by those of ordinary skill in the art that various changes may be made and equivalents may be substituted for elements thereof without departing from the scope of the present teachings as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present teachings not be limited to the particular examples illustrated by the drawings and described in the specification as the best mode presently contemplated for carrying out the teachings of the present disclosure, but that the scope of the present disclosure will include any embodiments falling within the foregoing description and the appended claims.

What is claimed:

1. A system for geographically locating a component of utility equipment, comprising:
a geo-location interface (GLI) in communication with and in proximity to the component, the GLI having a navigation system that provides geo-location data, wherein the GLI receives an input relating to an operating state of the component and transmits an output containing the geo-location data and an alert relating to the operating state; and
at least one remote station that receives a digital message based on the output from the GLI and generates a display based on the digital message.

2. The system of claim 1, wherein the GLI includes a logic unit that receives the input from the component, detects the operating state, and generates the alert based on the operating state.

3. The system of claim 1, wherein the GLI includes a memory that stores data relating to the component.

4. The system of claim 1, wherein the digital message is the alert from the GLI.

5. The system of claim 1, further comprising a central station, wherein the central station receives the alert from the GLI.

6. The system of claim 5, wherein the central station retransmits the alert from the GLI as the digital message.

7. The system of claim 5, wherein the central station includes software that analyzes the alert from the GLI, and wherein the digital message includes the alert and additional data resulting from the analysis.

8. The system of claim 1, wherein the component of utility equipment includes a housing, and wherein the GLI is disposed within the housing.

9. The system of claim 1, wherein said at least one remote station is a portable electronic device with at least one software application for receiving the digital message and generating the display.

10. A system for geographically locating a component of utility equipment, comprising:
a geo-location interface (GLI) in communication with and at generally the same location as the component, the GLI having a navigation system that provides geo-location data and a logic unit that receives an input relating to the operating state of the piece, wherein the logic unit detects the operating state, generates a digital message based on the operating state, and transmits an output containing the geo-location data and an alert relating to the operating state;
a central station that receives the alert from the GLI and generates a digital message based on the alert; and
a plurality of remote stations that selectively receive the digital message and generate a display based on the digital message.

11. The system of claim 10, wherein the GLI includes a non-volatile memory that stores data relating to the component.

12. The system of claim 10, wherein the central station retransmits the alert from the GLI as the digital message.

13. The system of claim 10, wherein the central station includes software that analyzes the alert from the GLI, and wherein the digital message includes the alert and additional data resulting from the analysis.

14. The system of claim 10, wherein the component includes a housing, and wherein the GLI is disposed outside of the housing.

15. The system of claim 10, wherein the plurality of remote stations are portable electronic devices each with at least one software application for receiving the digital message and displaying the corresponding information.

16. The system of claim 15, wherein the plurality of remote stations are selected from the group consisting of smartphones, hand-held devices, laptop computers, on-board vehicle computers, and tablets.

17. The system of claim 10, wherein the central station further comprises software that generates a control signal for controlling the component for the GLI, and wherein the GLI generates an output that operates the component of utility equipment.

18. A central station for a system for geographically locating a component of utility equipment, the central station comprising:
a memory containing instructions; and
a processor configured to execute the instructions to receive a first message from a geo-location interface (GLI) in communication with a component of utility equipment, to extract a location of the GLI and an operating state of the component from the first message, and to generate a second message to be transmitted to a remote station, the second message including the location of the GLI and the operating state of the component.

19. The central station of claim 18, wherein the processor is further configured to execute the instructions to determine driving directions from a location of the remote station to the location of the GLI and to include the directions in the second message.

20. The central station of claim 18, wherein the processor is further configured to execute the instructions to receive a third message from the remote station, to extract a desired operational command from the third message, and to generate a fourth message for the GLI to operate the component.
